(19) United States
(12) Patent Application Publication
(10) Pub. No.: US 2026/0092823 A1
(43) Pub. Date: Apr. 2, 2026

(54) Vibrator Device

(71) Applicant: SEIKO EPSON CORPORATION, Tokyo (JP)

(72) Inventors: Ryuta NISHIZAWA, Nagano (JP); Seiichiro OGURA, Minowa (JP)

(21) Appl. No.: 19/341,646

(22) Filed: Sep. 26, 2025

(30) Foreign Application Priority Data
Sep. 27, 2024 (JP) 2024-169416

(51) Int. Cl. G01L 5/00

(52) U.S. Cl. CPC G01L 5/0052

(57) ABSTRACT

A vibrator device includes a support substrate, a vibration element disposed on the support substrate, a circuit element including an oscillation circuit that causes the vibration element to oscillate and a time measurement circuit that generates time data, and a package that accommodates the support substrate, the vibration element, and the circuit element, and in a plan view of the support substrate, the circuit element overlaps the support substrate and the vibration element. In addition, a real-time clock is configured by generating a clock signal as the oscillation circuit causes the vibration element to oscillate and by generating time data as the time measurement circuit performs time measurement based on the clock signal.

The present application is based on, and claims priority from JP Application Serial Number 2024-169416, filed September 27, 2024, the disclosure of which is hereby incorporated by reference herein in its entirety.

### BACKGROUND

### 1. Technical Field

The present disclosure relates to a vibrator device.

### 2. Related Art

JP-A-2019-152563 discloses an impact detection device that can detect an impact or the like applied to a transport product. Then, the impact detection device is configured such that an acceleration sensor, a real-time clock, an operation switch, an LED, a storage section, a wireless communication section, a control section, and a battery are accommodated in a semi-transparent or transparent resin housing.

However, in JP-A-2019-152563, a disposition of respective portions accommodated in a housing is not clear, and it is difficult to reduce a size of an impact detection device.

### SUMMARY

A vibrator device includes a support substrate, a vibration element disposed on the support substrate, a circuit element including an oscillation circuit that causes the vibration element to oscillate and a time measurement circuit that generates time data, and a package that accommodates the support substrate, the vibration element, and the circuit element, and in a plan view of the support substrate, the circuit element overlaps the support substrate and the vibration element.

### BRIEF DESCRIPTION OF THE DRAWINGS

FIG. 1 is a top view of a vibrator device according to a first embodiment.

FIG. 2 is a cross-sectional view taken along line II-II of FIG. 1.

FIG. 3 is an exploded perspective view illustrating a disposition of respective portions in a recessed portion.

FIG. 4 is a top view of a vibration element.

FIG. 5 is a top view of a physical quantity sensor.

FIG. 6 is a block diagram illustrating a circuit included in a circuit element.

FIG. 7 is a diagram illustrating an example of event data.

FIG. 8 is a top view of a vibrator device according to a second embodiment.

FIG. 9 is a cross-sectional view taken along line IX-IX of FIG. 8.

FIG. 10 is a cross-sectional view of a vibrator device according to a third embodiment.

FIG. 11 is a top view of a vibrator device according to a fourth embodiment.

FIG. 12 is a cross-sectional view taken along line XII-XII of FIG. 11.

FIG. 13 is a top view of a vibrator device according to a fifth embodiment.

FIG. 14 is a top view of a vibrator device according to a sixth embodiment.

### DESCRIPTION OF EMBODIMENTS

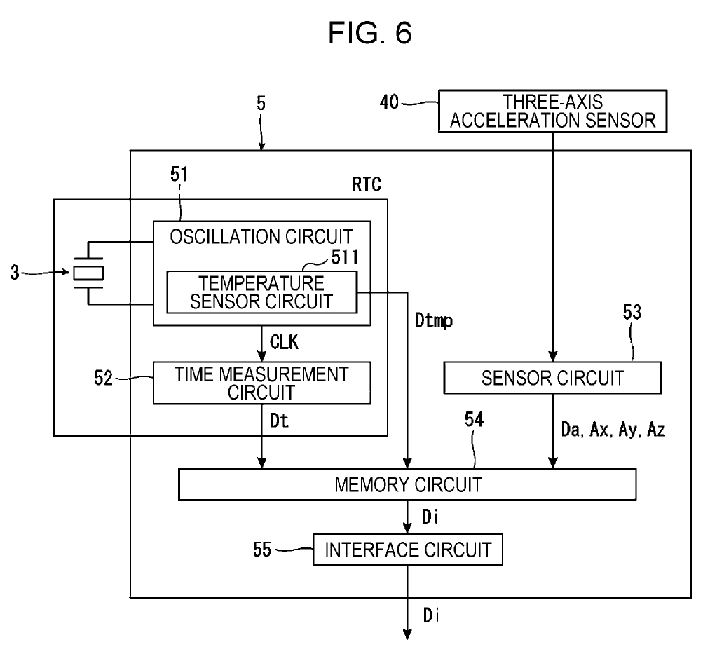

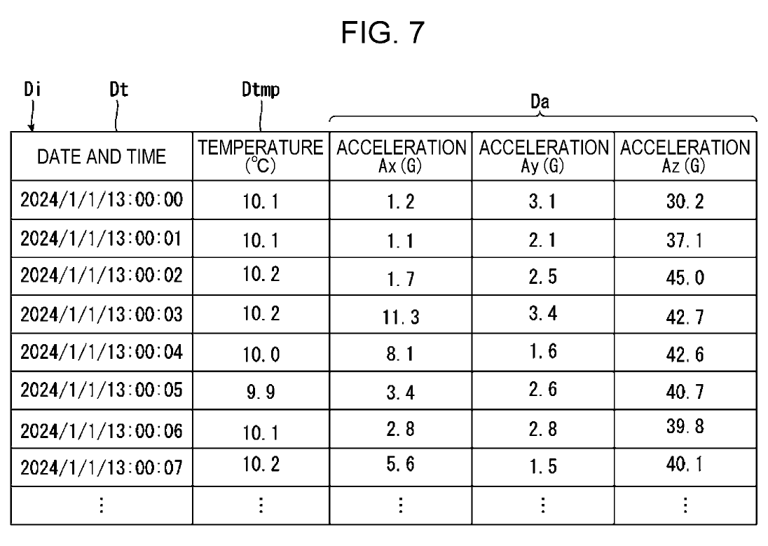

Hereinafter, a vibrator device of the present disclosure will be described in detail based on the embodiments illustrated in the accompanying drawings. For the sake of convenience of description, in each drawing except FIGS. 6 and 7, three axes orthogonal to each other are illustrated as an X axis, a Y axis, and a Z axis. Then, a direction along the X axis is also referred to as an "X-axis direction", a direction along the Y axis is also referred to as a "Y-axis direction", and a direction along the Z axis is also referred to as a "Z-axis direction". In addition, an arrow side of each axis is also referred to as a "plus side", and an opposite side is also referred to as a "minus side". In addition, the Z axis is along a vertical direction, and an arrow side is referred to as "up" and an opposite side is referred to as "down".

### FIRST EMBODIMENT

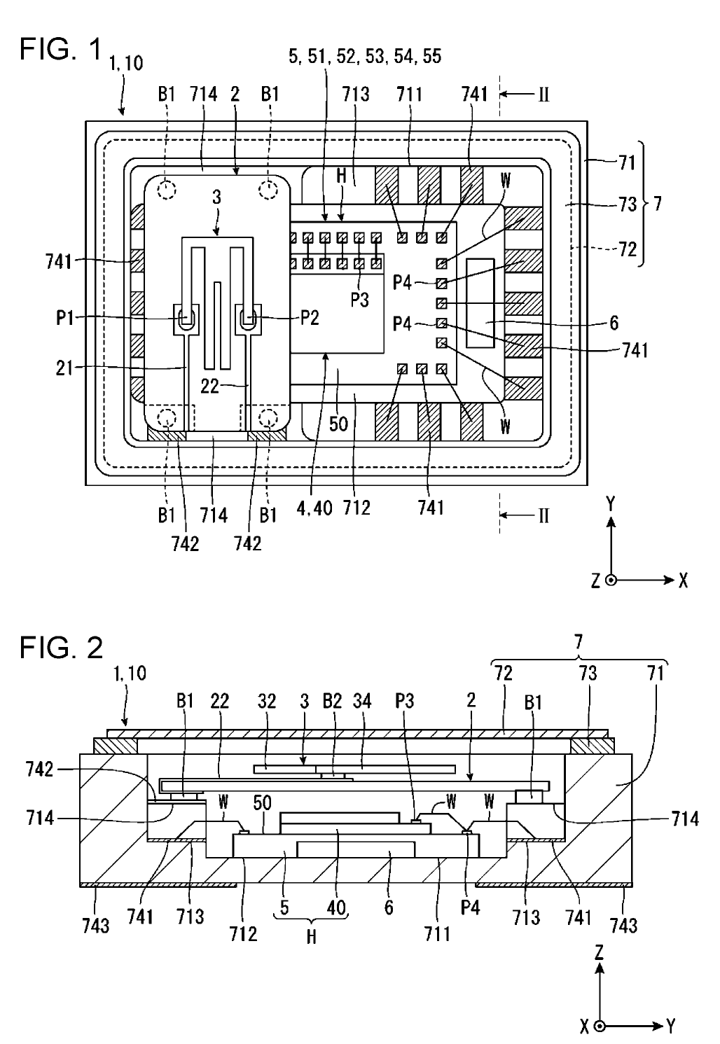

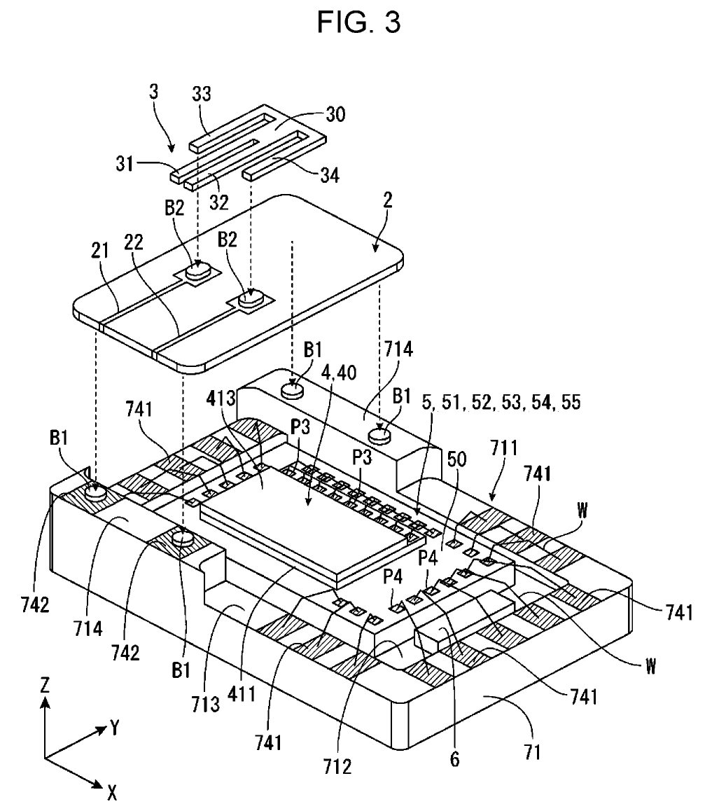

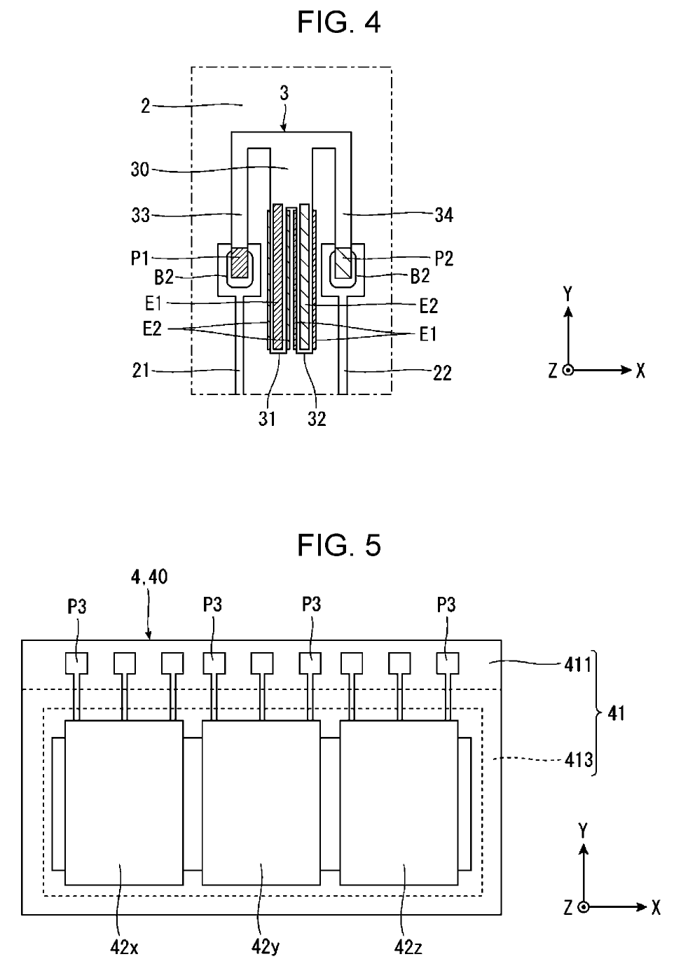

FIG. 1 is a top view of a vibrator device according to a first embodiment. FIG. 2 is a cross-sectional view taken along line II-II of FIG. 1. FIG. 3 is an exploded perspective view illustrating a disposition of each portion in a recessed portion. FIG. 4 is a top view of a vibration element. FIG. 5 is a top view of a physical quantity sensor. FIG. 6 is a block diagram illustrating a circuit included in a circuit element. FIG. 7 is a diagram illustrating an example of event data.

A vibrator device 1 illustrated in FIG. 1 is an impact logger 10 that is mounted on a product being transported, detects an impact or the like applied to the product, and can store the detected impact together with generation time of the impact. According to the impact logger 10, checking can be performed when and to what extent an impact is applied to the product being transported.

Therefore, according to a side of a transport requester (here, referred to as a product manufacturer for the sake of convenience of description) who requests transport of a product, for example, when a damage, failure, or the like occurs on a product during transportation, the date and time when the damage, failure, or the like occurs, a cause of the damage, failure, or the like, the location of responsibility, and the like can be clarified, and a subsequent respondence to a transporter is easily made. Furthermore, by checking the impact applied to a product during transportation, a mechanical design of the product can be reviewed, and the product can be improved to be less likely to fail. In addition, a shape and size of a cushioning material for protecting a product from the impact can be reviewed, and for example, when the cushioning material can be reduced as a result of the review, product cost and transportation cost can be reduced accordingly.

Meanwhile, according to a transporter side that transports a product, it can be effectively used as evidence to prove that the cause of damage, failure, or the like is not in a transporter itself. In addition, by proving that the impact applied during transportation is extremely small compared to a partner by using the impact logger 10 and appealing to high transport quality for that reason, the transporter side can be differentiated from other transporters.

In this way, the impact logger 10 brings various merits to both a transport requester side and a transporter side. In particular, the vibrator device 1 of the present embodiment is inexpensive and small in size as compared with the impact logger (for example, the impact detection device described in JP-A-2019-152563), of the related art and the cost and size are hardly increased by mounting the impact logger 10. Therefore, the impact logger 10 is extremely convenient.

As illustrated in FIG. 1, the impact logger 10 includes a support substrate 2, a vibration element 3, a physical quantity sensor 4, a circuit element 5, a battery 6, and a package 7 that accommodates the respective portions. The impact logger 10 is mounted on a product such that, for example, a plus side in the Z-axis direction faces a vertical direction upper side.

### PACKAGE 7

First, the package 7 is described. As illustrated in FIGS. 1 and 2, the package 7 includes a cavity-shaped base 71 having a recessed portion 711 that is open on an upper surface, and a plate-shaped lid 72 that is bonded to an upper surface of the base 71 through a seam ring 73 and closes an opening of the recessed portion 711. The package 7 has an internal space, and the support substrate 2, the vibration element 3, the physical quantity sensor 4, the circuit element 5, and the battery 6 are accommodated in the internal space. In addition, the internal space is airtightly sealed and is in a depressurized state, preferably in a state closer to a vacuum. Thereby, viscous resistance of the internal space is reduced, and the vibration element 3 can be efficiently oscillated. However, atmosphere of the internal space is not limited in particular.

A constituent material of the base 71 is not limited in particular, and for example, various ceramics such as aluminum oxide can be used. In addition, a constituent material of the lid 72 is not limited in particular but may be a member of which linear expansion coefficient is close to a linear expansion coefficient of the constituent material of the base 71. For example, when the constituent material of the base 71 is ceramics, an alloy such as a Kovar is preferable. With such a configuration, the package 7 becomes hard, and a mechanical strength of the impact logger 10 increases. In addition, as is described below, since respective portions can be electrically coupled to each other by an internal wiring line (not illustrated) formed on the base 71, a wiring substrate or the like for electrical coupling is not required. Therefore, the impact logger 10 can also be lightened and reduced in size. With such a configuration, an inherent vibration frequency of the impact logger 10 is easily increased, and an inherent vibration frequency of the impact logger 10 can be made sufficiently higher than an impact vibration frequency generated during transportation. Therefore, resonance of the impact logger 10 due to the impact generated during transportation can be effectively suppressed, and the impact generated during transportation can be detected with high accuracy.

In addition, as illustrated in FIG. 2, the base 71 includes a bottom surface 712 of a recessed portion 711, a first step difference surface 713 that is located above (on the plus side in the Z-axis direction) the bottom surface 712 and parallel to the bottom surface 712, and a second step difference surface 714 that is located above (on the plus side in the Z-axis direction) the first step difference surface 713 and parallel to the bottom surface 712. In addition, as illustrated in FIG. 1, in a plan view from the Z-axis direction, the first step difference surface 713 is a frame shape surrounding the bottom surface 712. In addition, in a plan view from the Z-axis direction, the second step difference surface 714 is divided into two to be disposed to face the Y-axis direction with the bottom surface 712 interposed therebetween. In addition, the second step difference surface 714 is disposed to be biased on an X-axis direction minus side. Then, the circuit element 5 and the battery 6 are disposed side by side on the bottom surface 712 in the X-axis direction, the physical quantity sensor 4 is disposed on an upper surface of the circuit element 5, the support substrate 2 is disposed on the second step difference surface 714, and the vibration element 3 is disposed on an upper surface of the support substrate 2.

In addition, as illustrated in FIG. 1, a plurality of first internal terminals 741 are disposed on the first step difference surface 713, and a plurality of second internal terminals 742 are disposed on the second step difference surface 714. In addition, as illustrated in FIG. 2, a plurality of external terminals 743 are disposed on a lower surface of the base 71. Then, the plurality of first internal terminals 741 are electrically coupled to a predetermined second internal terminal 742 or a predetermined external terminal 743 through internal wiring line (not illustrated) formed in the base 71. In addition, each first internal terminal 741 is electrically coupled to the circuit element 5 through a conductive wire W (bonding wire), and each second internal terminal 742 is electrically coupled to the vibration element 3 through a conductive bonding member B1 and wiring lines 21 and 22 to be described below formed on the support substrate 2. The number and disposition of the first and second internal terminals 741 and 742 and the external terminal 743 are not limited in particular, and may be appropriately set according to the number of terminals of the circuit element 5 and the vibration element 3.

A size of the package 7 is not limited in particular, but the X-axis direction length × Y-axis direction length is preferably, for example, 10 mm or less × 10 mm or less. Thereby, the impact logger 10 has a sufficiently small size. In the present embodiment, a size of the impact logger 10 is about 7 mm × about 5 mm.

### VIBRATION ELEMENT 3

As illustrated in FIG. 4, the vibration element 3 is a quartz crystal vibrator of a tuning fork type. The vibration element 3 is obtained by patterning a Z cut quartz crystal substrate into a predetermined outer shape by etching or the like, and includes a base portion 30, a pair of vibrating arms 31 and 32 extending from the base portion 30 in the Y-axis direction minus side, and a pair of L-shaped support arms 33 and 34 extending from the base portion 30. Then, the vibration element 3 is bonded to an upper surface of the support substrate 2 at tip portions of the support arms 33 and 34 through a conductive bonding members B2. In addition, the vibration element 3 includes a first excitation electrode E1 disposed on upper and lower surfaces of the vibrating arm 31 and on both side surfaces of the vibrating arm 32, and a second excitation electrode E2 disposed on both side surfaces of the vibrating arm 31 and on upper and lower surfaces of the vibrating arm 32. In addition, the first excitation electrode E1 is electrically coupled to a first coupling terminal P1 disposed at a tip portion of the support arm 33 through a wiring line (not illustrated), and the second excitation electrode E2 is electrically coupled to a second coupling terminal P2 disposed at a tip portion of the support arm 34 through a wiring line (not illustrated). In the vibration element 3, when a drive signal (alternating voltage) is applied between the first and second excitation electrodes E1 and E2 through the first and second coupling terminals P1 and P2, the vibrating arms 31 and 32 vibrate in a plane by being repeatedly approaching and separating from each other.

As described above, the vibration element 3 is described, but a configuration of the vibration element 3 is not limited in particular. For example, a configuration using a quartz crystal substrate cut out at a cut angle other than the Z cut, such as an AT cut or an SC cut, may be used.

As illustrated in FIG. 2, the vibration element 3 described above is located above (on a plus side in the Z-axis direction) any of the support substrate 2, the physical quantity sensor 4, and the circuit element 5. Therefore, for example, before being sealed by the lid 72, a frequency adjustment process of adjusting a resonance frequency of the vibration element 3 by irradiating upper surfaces of the vibrating arms 31 and 32 with a laser and removing a part of each of the first and second excitation electrodes E1 and E2 can be easily performed without being disturbed by other members.

### SUPPORT SUBSTRATE 2

As illustrated in FIGS. 1 to 3, the support substrate 2 is an approximately rectangular plate shape having a thickness in the Z-axis direction, and is bonded to the second step difference surface 714 through the conductive bonding member B1 at an outer edge portion. In addition, the support substrate 2 is located on a lower side of the vibration element 3 and supports the vibration element 3 from the lower side at a central portion. In addition to a function of electrically relaying the vibration element 3 and the base 71, the support substrate 2 has a function of absorbing or reducing a stress generated due to deformation of the base 71 or a thermal stress generated due to a difference in linear expansion coefficient, and making it difficult for the stress to be transferred to the vibration element 3.

The support substrate 2 is configured with a quartz crystal substrate in the same manner as the vibration element 3. Thereby, the support substrate 2 has a high mechanical strength. In addition, by configuring the support substrate 2 with the same quartz crystal substrate as the vibration element 3, linear expansion coefficients of the support substrate 2 and the vibration element 3 may be substantially equal to each other. Therefore, thermal stress due to a difference in the linear expansion coefficients between the support substrate 2 and the vibration element 3 is not substantially generated, and the vibration element 3 is less likely to receive a stress. Therefore, the drive of the vibration element 3 is more stable. In particular, the support substrate 2 is configured with the same Z cut quartz crystal substrate as the vibration element 3. In addition, an orientation of a crystal axis also matches the vibration element 3. Since the quartz crystal has a different linear expansion coefficient in each of the X-axis (electric axis) direction, the Y-axis (mechanical axis) direction, and the Z-axis (optical axis) direction, the thermal stress described above is less likely to occur between the support substrate 2 and the vibration element 3 by setting the same cut angle for the support substrate 2 and the vibration element 3 and further aligning orientations of crystal axes of the support substrate 2 and the vibration element 3. Therefore, the vibration element 3 is less likely to receive a stress, and drive of the vibration element 3 is more stable.

The support substrate 2 is not limited thereto, and is formed of, for example, a quartz crystal substrate having the same cut angle as the vibration element 3, but a direction of the crystal axis may be different from a direction of the vibration element 3. In addition, the support substrate 2 may be formed of a quartz crystal substrate having a cut angle different from a cut angle of the vibration element 3. In addition, the support substrate 2 may not be formed of a quartz crystal substrate, and may be formed of, for example, a silicon substrate, a resin substrate, or the like. In addition, for example, the substrate may be a tape automated bonding (TAB) mounting substrate having a support substrate and a lead extending from the support substrate.

In addition, two wiring lines 21 and 22 for electrically coupling the first and second coupling terminals P1 and P2 included in the vibration element 3 to the second internal terminal 742 disposed on the second step difference surface 714 of the base 71 are disposed on the support substrate 2. Then, one end portion of each of the wiring lines 21 and 22 is electrically coupled to the second internal terminal 742 through the conductive bonding member B1, and the other end portion of each of the wiring lines 21 and 22 are electrically coupled to the first and second coupling terminals P1 and P2 through the conductive bonding member B2. The bonding members B1 and B2 are not limited in particular as long as both conductivity and bonding property are provided, and, for example, various metal bumps such as a gold bump, a silver bump, a copper bump, and a solder bump, a conductive adhesive in which a conductive filler such as a silver filler is dispersed in various adhesives such as a polyimide-based adhesive, an epoxy-based adhesive, a silicone-based adhesive, and an acrylic-based adhesive, and the like can be used.

### PHYSICAL QUANTITY SENSOR 4

The physical quantity sensor 4 is a three-axis acceleration sensor 40 that can detect an acceleration Ax in the X-axis direction, an acceleration Ay in the Y-axis direction, and an acceleration Az in the Z-axis direction. The three-axis acceleration sensor 40 is a silicon micro electro mechanical systems (MEMS). Therefore, the physical quantity sensor 4 can be reduced in size.

In addition, as illustrated in FIG. 5, the three-axis acceleration sensor 40 includes a package 41, and an X-axis acceleration sensor element 42x, a Y-axis acceleration sensor element 42y, and a Z-axis acceleration sensor element 42z which are accommodated in the package 41. In addition, the package 41 includes a base 411 that supports respective sensor elements 42x, 42y, and 42z, and a lid 413 that is bonded to an upper surface of the base 411 and accommodates the respective sensor elements 42x, 42y, and 42z between the base 411 and the lid 413. In addition, the base 411 is larger than the lid 413, and a part (an end portion on the plus side in the Y-axis direction) of an upper surface thereof is exposed to the outside from the lid 413. Then, a plurality of coupling terminals P3, which are electrically coupled to the respective sensor elements 42x, 42y, and 42z, are disposed in a portion of the upper surface of the base 411 which is exposed from the lid 413.

The three-axis acceleration sensor 40 can be formed by, for example, a process of forming the base 411 from one silicon layer (handle layer) of a silicon on insulator (SOI) substrate and forming the respective sensor elements 42x, 42y, and 42z from the other silicon layer (device layer), and a process of bonding the lid 413 formed from a silicon substrate to the base 411. With such a configuration, the three-axis acceleration sensor 40 can be manufactured by a manufacturing method conforming to a silicon semiconductor process.

Hereinafter, the X-axis acceleration sensor element 42x, the Y-axis acceleration sensor element 42y, and the Z-axis acceleration sensor element 42z will be briefly described.

The X-axis acceleration sensor element 42x includes a fixed comb-tooth electrode fixed to the base 411, and a movable comb-tooth electrode that is disposed to mesh with the fixed comb-tooth electrode and displaceable in the X-axis direction with respect to the base 411, and the fixed comb-tooth electrode and the movable comb-tooth electrode are disposed to face each other in the X-axis direction. Then, when an acceleration Ax in the X-axis direction is applied to the X-axis acceleration sensor element 42x, the movable comb-tooth electrode is displaced in the X-axis direction, and capacitance between the fixed comb-tooth electrode and the movable comb-tooth electrode changes according to the displacement. Therefore, the change in the capacitance can be taken out as an output signal from the coupling terminal P3, and the acceleration Ax can be detected based on the output signal. However, the configuration of the X-axis acceleration sensor element 42x is not limited in particular as long as the acceleration Ax can be detected.

The Y-axis acceleration sensor element 42y is configured by rotating the X-axis acceleration sensor element 42x around the Z axis by 90°. That is, the Y-axis acceleration sensor element 42y includes a fixed comb-tooth electrode fixed to the base 411 and a movable comb-tooth electrode that is disposed to mesh with the fixed comb-tooth electrode and displaceable in the Y-axis direction with respect to the base 411, and the fixed comb-tooth electrode and the movable comb-tooth electrode are disposed to face each other in the Y-axis direction. When an acceleration Ay in the Y-axis direction is applied to the Y-axis acceleration sensor element 42y, the movable comb-tooth electrode is displaced in the Y-axis direction, and capacitance between the fixed comb-tooth electrode and the movable comb-tooth electrode changes according to the displacement. Therefore, the change in the capacitance can be taken out from the coupling terminal P3 as an output signal, and the acceleration Ay can be detected based on the output signal. However, the configuration of the Y-axis acceleration sensor element 42y is not limited in particular as long as the acceleration Ay can be detected.

The Z-axis acceleration sensor element 42z includes a fixed comb-tooth electrode fixed to the base 411, and a movable comb-tooth electrode that is disposed to mesh with the fixed comb-tooth electrode and displaceable in the Z-axis direction with respect to the base 411, and the fixed comb-tooth electrode and the movable comb-tooth electrode are disposed to face each other. When an acceleration Az in the Z-axis direction is applied to the Z-axis acceleration sensor element 42z, the movable comb-tooth electrode is displaced in the Z-axis direction, and capacitance between the fixed comb-tooth electrode and the movable comb-tooth electrode changes according to the displacement. Therefore, the change in the capacitance can be taken out as an output signal from the coupling terminal P3, and the acceleration Az can be detected based on the output signal. However, the configuration of the Z-axis acceleration sensor element 42z is not limited in particular as long as the acceleration Az can be detected.

As illustrated in FIGS. 1 to 3, the three-axis acceleration sensor 40 having such a configuration is bonded to an upper surface of the circuit element 5 through a bonding member (not illustrated). The respective coupling terminals P3 are electrically coupled to the circuit element 5 through a conductive wire W (bonding wire).

As described above, the three-axis acceleration sensor 40 is described, but the configuration of the three-axis acceleration sensor 40 is not limited in particular. For example, the base 411 and the lid 413 may be formed of a material other than silicon, such as a glass material. In addition, the package 41 may be divided for each of the sensor elements 42x, 42y, and 42z. In this case, for example, the sensor elements 42x, 42y, and 42z may be disposed to overlap each other in the Z-axis direction. In addition, two or more sensor elements selected from the sensor elements 42x, 42y, and 42z may be integrally formed as one sensor element. In other words, one sensor element may be configured to detect two or more of the accelerations Ax, Ay, and Az. In addition, the physical quantity sensor 4 is not limited to the three-axis acceleration sensor having three acceleration detection axes, and may be configured to have two acceleration detection axes or may be configured to have one acceleration detection axis. In this case, at least the Z-axis acceleration sensor element 42z that can detect the acceleration Az in the Z-axis direction can be preferably provided. Thereby, an impact in a vertical direction that is most likely to occur during transportation and is also likely to cause a failure or the like can be more reliably detected. In addition, the three-axis acceleration sensor 40 may not include the package 41, and the sensor elements 42x, 42y, and 42z may each be exposed to an internal space of the package 7. With such a configuration, the impact logger 10 can be further reduced in size.

### CIRCUIT ELEMENT 5

As illustrated in FIGS. 1 to 3, the circuit element 5 is bonded to the bottom surface 712 of the recessed portion 711 through a bonding member (not illustrated). In addition, the circuit element 5 is configured with one chip. In this way, by configuring the circuit element 5 with one chip, the circuit element 5 can be reduced in size as compared with a case where the circuit element 5 is configured with a plurality of chips, for example, in the embodiment to be described below. Therefore, the impact logger 10 can be reduced in size. In addition, since an inherent vibration frequency of the impact logger 10 can be further increased by reduction in size, resonance with the impact during transportation can be more effectively suppressed, and the impact can be more accurately detected.

In addition, the circuit element 5 is disposed in a posture in which an active surface 50 on which a plurality of coupling terminals P4 are formed is directed upward (on a plus side in the Z-axis direction), and the three-axis acceleration sensor 40 is disposed on the active surface 50. Then, some of the plurality of coupling terminals P4 are electrically coupled to the first internal terminal 741 disposed on the base 71 through the wire W, and the others of the plurality of coupling terminals P4 are electrically coupled to the three-axis acceleration sensor 40 through the wire W. In the following, a stacked body of the circuit element 5 and the three-axis acceleration sensor 40 is also referred to as a stacked body H.

The circuit element 5 is, for example, a micro control unit (MCU), and collectively controls each portion of the impact logger 10. Then, as illustrated in FIG. 6, the circuit element 5 includes a temperature compensated oscillation circuit 51 that causes the vibration element 3 to oscillate, a time measurement circuit 52 that generates time data Dt, a sensor circuit 53 that processes an output signal of the three-axis acceleration sensor 40 to obtain the accelerations Ax, Ay, and Az, a memory circuit 54 that stores processing data Da including the accelerations Ax, Ay, and Az obtained by the sensor circuit 53 in association with the time data Dt as event data Di, an interface circuit 55 for performing communication with the outside, and a control circuit (not illustrated) that controls the respective circuits 51 to 55.

The temperature compensated oscillation circuit 51 includes a temperature sensor circuit 511 that detects temperature of the vibration element 3. The temperature sensor circuit 511 is not limited in particular, and is, for example, a circuit including an NTC thermistor which is a resistor of which resistance value changes according to the temperature, and is a circuit that detects the temperature of the vibration element 3 by using the change in the resistance value. In addition, the oscillation circuit 51 is electrically coupled to the vibration element 3, amplifies an output signal of the vibration element 3, and feeds back the amplified signal to the vibration element 3 to cause the vibration element 3 to oscillate to generate a clock signal CLK. A frequency of the clock signal CLK is, for example, 32.768 kHz. In addition, the oscillation circuit 51 compensates for frequency-temperature characteristics of the clock signal CLK based on the temperature of the vibration element 3 detected by the temperature sensor circuit 511. That is, the temperature is compensated such that a frequency variation of the clock signal CLK is less than the frequency-temperature characteristics of the vibration element 3 itself. With such a configuration, frequency variation of the clock signal CLK due to a temperature change can be suppressed, and the clock signal CLK with high precision can be generated.

An oscillation circuit such as a Pierce oscillation circuit, an inverter-type oscillation circuit, a Colpitts oscillation circuit, or a Hartley oscillation circuit can be used as the oscillation circuit 51. In addition, the temperature compensation may be performed, for example, when the frequency of the clock signal CLK is adjusted by adjusting capacitance of a variable capacitance circuit coupled to the oscillation circuit 51, or may be performed by adjusting the frequency of the clock signal CLK generated by the oscillation circuit 51 with a PLL circuit or a direct digital synthesizer circuit.

The clock signal CLK generated by the oscillation circuit 51 is divided by a frequency division circuit (not illustrated) and then input to the time measurement circuit 52. For example, a frequency division ratio of the frequency division circuit is 32. Therefore, the frequency of the clock signal CLK after the frequency division is 1.024 kHz. The time measurement circuit 52 measures time based on the clock signal CLK and generates time data Dt. The time data Dt includes seconds, minutes, hours, days, months, and years as time digits. That is, in the impact logger 10, a real-time clock RTC is configured by generating the clock signal CLK as the oscillation circuit 51 causes the vibration element 3 to oscillate, and by generating the time data Dt as the time measurement circuit 52 performs time measurement based on the clock signal CLK. With such a configuration, the time data Dt with high accuracy can be generated.

In addition, the sensor circuit 53 controls drive of the physical quantity sensor 4 (three-axis acceleration sensor 40), obtains the acceleration Ax based on an output signal of the X-axis acceleration sensor element 42x, obtains the acceleration Ay based on an output signal of the Y-axis acceleration sensor element 42y, and obtains the acceleration Az based on an output signal of the Z-axis acceleration sensor element 42z. The accelerations Ax, Ay, and Az are output as the processing data Da.

In addition, as illustrated in FIG. 7, the memory circuit 54 stores, for example, the processing data Da (accelerations Ax, Ay, and Az) output from the sensor circuit 53, the temperature data Dtmp which is data on temperatures detected by the temperature sensor circuit 511, and the time data Dt generated by the time measurement circuit 52 in association with each other as the event data Di. That is, the memory circuit 54 stores the event data Di, which is obtained by associating the current time, an impact generated at that time, and the temperature at that time with each other, over time for each measurement period. In this way, the vibrator device 1 can be suitably used as the impact logger 10 by storing the event data Di in the memory circuit 54. In particular, since the event data Di includes the temperature data Dtmp, the impact logger 10 includes a large amount of information.

With such a configuration, in addition to figure out a cause such as a failure based on an impact, for example, checking can be easily performed whether a product (in particular, a product that requires refrigeration or freezing) is constantly maintained in an appropriate temperature zone during transportation based on the temperature data Dtmp. In addition, a failure caused by being exposed to excessively high temperature or excessively low temperature during transportation, or a failure caused by dew condensation occurring due to a rapid temperature change during transportation can be figured out. The memory circuit 54 may not store the event data Di for the entire measurement period, and may store the event data Di, for example, only when the accelerations Ax, Ay, and Az equal to or greater than a preset threshold are detected. With such a configuration, capacity of the memory circuit 54 can be reduced.

In addition, the interface circuit 55 transmits and receives signals, receives an input (command) from the outside, and outputs the event data Di stored in the memory circuit 54. A communication method is not limited in particular, and for example, serial peripheral interface (SPI) communication can be used.

### BATTERY 6

As illustrated in FIGS. 1 to 3, the battery 6 is bonded to the bottom surface 712 of the recessed portion 711 through a bonding member (not illustrated). In addition, the battery 6 is disposed side by side with the circuit element 5 in the X-axis direction. Then, the battery 6 supplies power to the circuit element 5. That is, the circuit element 5 is driven by the power supplied from the battery 6. Therefore, the impact logger 10 can operate even without the power supplied from the outside. The battery 6 is not limited in particular, and for example, an individual battery, a coin-type battery, or the like can also be used.

However, disposition of the battery 6 is not limited in particular, and for example, the battery 6 may be disposed on an upper surface of the circuit element 5 together with the physical quantity sensor 4, or may be disposed on an upper surface of the physical quantity sensor 4.

As described above, a configuration of the vibrator device 1 is described. In such a vibrator device 1, the vibration element 3, the support substrate 2, the three-axis acceleration sensor 40, and the circuit element 5 are disposed side by side in the Z-axis direction. In addition, in a plan view from the Z-axis direction, the vibration element 3, the support substrate 2, the three-axis acceleration sensor 40, and the circuit element 5 overlap each other. That is, in a plan view from the Z-axis direction, the vibration element 3, the support substrate 2, the three-axis acceleration sensor 40, and the circuit element 5 respectively overlap with all the other members. Specifically, the vibration element 3 overlaps the support substrate 2, the three-axis acceleration sensor 40, and the circuit element 5, the support substrate 2 overlaps the vibration element 3, the three-axis acceleration sensor 40, and the circuit element 5, the three-axis acceleration sensor 40 overlaps the vibration element 3, the support substrate 2, and the circuit element 5, and the circuit element 5 overlaps the vibration element 3, the support substrate 2, and the three-axis acceleration sensor 40. With such a configuration, since the vibration element 3, the support substrate 2, the three-axis acceleration sensor 40, and the circuit element 5 are disposed to overlap each other in the Z-axis direction, and thus, a planar spread of the vibrator device 1 in the X-axis direction and the Y-axis direction, that is, a footprint can be suppressed, and the vibrator device 1 can be reduced in size.

In addition, as in the present embodiment, by disposing the circuit element 5 on the bottom surface 712 and disposing the three-axis acceleration sensor 40 on an upper surface of the circuit element 5, a large area of the circuit element 5 that can be disposed can be secured, and a larger circuit element 5 can be mounted. Therefore, the circuit element 5 having higher performance can be mounted, or the circuit element 5 having more functions can be mounted. In particular, when a programmable circuit element 5 of which function that can be freely customized by a user is mounted, a size of the circuit element 5 is easily increased, and thus, a configuration of the present embodiment is effective.

The vibrator device 1 is described above. As described above, the vibrator device 1 includes the support substrate 2, the vibration element 3 disposed on the support substrate 2, the circuit element 5 including the oscillation circuit 51 that causes the vibration element 3 to oscillate and the time measurement circuit 52 that generates the time data Dt, and the package 7 that accommodates the support substrate 2, the vibration element 3, and the circuit element 5. Then, in a plan view of the support substrate 2, that is, in a plan view from the Z-axis direction, the circuit element 5 overlaps the support substrate 2 and the vibration element 3. With such a configuration, since the vibration element 3, the support substrate 2, and the circuit element 5 are disposed to overlap in the Z-axis direction, a planar spread of the vibrator device 1 in the X-axis direction and the Y-axis direction, that is, a footprint can be suppressed, and the vibrator device 1 can be reduced in size.

In addition, as described above, in the vibrator device 1, the real-time clock RTC is configured by generating the clock signal CLK as the oscillation circuit 51 causes the vibration element 3 to oscillate and by generating the time data Dt as the time measurement circuit 52 performs time measurement based on the clock signal CLK. With such a configuration, the time data Dt with high accuracy can be generated.

In addition, as described above, the vibrator device 1 includes the three-axis acceleration sensor 40 serving as the physical quantity sensor 4 that detects the accelerations Ax, Ay, and Az, which are physical quantities. Then, the circuit element 5 includes the sensor circuit 53 that processes an output signal of the three-axis acceleration sensor 40, and the memory circuit 54 that stores the processing data Da processed by the sensor circuit 53 and the time data Dt in association with each other. With such a configuration, the vibrator device 1 can be suitably used as the impact logger 10 that can detect an impact or the like applied to a product during transportation and storing the detected impact together with generation time of the impact.

In addition, as described above, the physical quantity sensor 4 is disposed in the package 7 and overlaps the circuit element 5 in a plan view of the support substrate 2, that is, a plan view from the Z-axis direction. With such a configuration, a planar spread of the vibrator device 1 in the X-axis direction and the Y-axis direction, that is, the footprint can be suppressed, and the vibrator device 1 can be reduced in size.

In addition, as described above, the package 7 includes the base 71 having the recessed portion 711 and the lid 72 that closes an opening of the recessed portion 711 and is coupled to the base 71. Then the stacked body H in which the circuit element 5 and the three-axis acceleration sensor 40 are stacked is disposed on the bottom surface 712 of the recessed portion 711, the support substrate 2 supported by the base 71 is disposed on the lid 72 side of the stacked body H, and the vibration element 3 is disposed on a surface of the support substrate 2 on the lid 72 side. With such a configuration, the circuit element 5, the three-axis acceleration sensor 40, the support substrate 2, and the vibration element 3 can be disposed to overlap each other in the Z-axis direction, and thus, the vibrator device 1 can be reduced in size.

In addition, as described above, the circuit element 5 is disposed on the bottom surface 712 of the recessed portion 711, and the three-axis acceleration sensor 40 is disposed on a surface of the circuit element 5 on the lid 72 side. With such a configuration, a larger circuit element 5 can be mounted. Therefore, the circuit element 5 having higher performance can be mounted, or the circuit element 5 having more functions can be mounted. In particular, when a programmable circuit element 5 of which function that can be freely customized by a user is mounted, a size of the circuit element 5 is easily increased, and thus, a configuration of the present embodiment is effective.

In addition, as described above, the circuit element 5 includes the temperature sensor circuit 511 that detects temperature. Then, the memory circuit 54 stores the temperature data Dtmp detected by the temperature sensor circuit 511, the processing data Da processed by the sensor circuit 53, and the time data Dt in association with each other. With such a configuration, the impact logger 10 can store the temperature together with the impact, and thus, the impact logger 10 has a large amount of information.

### SECOND EMBODIMENT

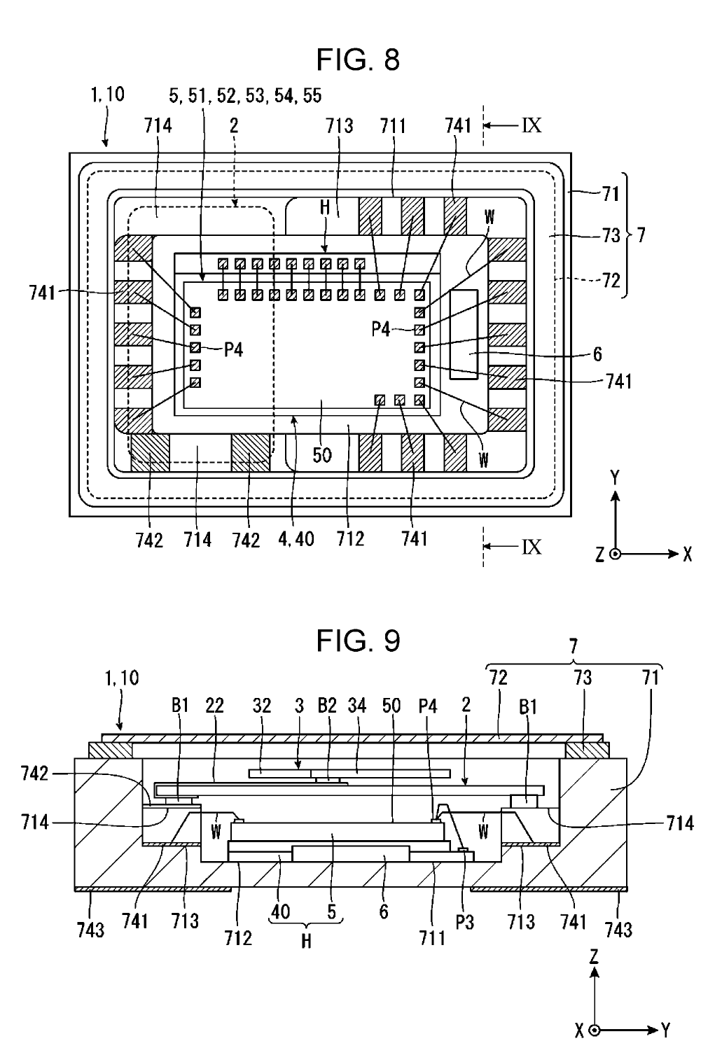

FIG. 8 is a top view of a vibrator device according to a second embodiment. FIG. 9 is a cross-sectional view taken along line IX-IX of FIG. 8.

A vibrator device 1 of the present embodiment is the same as the vibrator device 1 of the first embodiment described above, except that a configuration of a stacked body H is different therefrom. In the following description, the present embodiment will be described with a focus on differences from the first embodiment described above, and the description of the same matters will not be repeated. In addition, in each drawing of the present embodiment, the same reference numerals are assigned to the same configurations as in the embodiment described above.

As illustrated in FIGS. 8 and 9, in the vibrator device 1 of the present embodiment, a stacking order of the stacked body H is opposite to the stacking order of the first embodiment, the three-axis acceleration sensor 40 is disposed on the bottom surface 712 of the recessed portion 711, and the circuit element 5 is disposed on an upper surface of the three-axis acceleration sensor 40. In this way, by disposing the three-axis acceleration sensor 40 on a lower side of the circuit element 5, a larger three-axis acceleration sensor 40 can be mounted. Therefore, for example, as compared with the first embodiment described above, capacitance formed between a fixed comb-tooth electrode and a movable comb-tooth electrode of each of the sensor elements 42x, 42y, and 42z can be increased, and the accelerations Ax, Ay, and Az can be detected with higher accuracy.

As described above, in the vibrator device 1 of the present embodiment, the three-axis acceleration sensor 40 is disposed on the bottom surface 712 of the recessed portion 711, and the circuit element 5 is disposed on a surface of the three-axis acceleration sensor 40 on the lid 72 side. With such a configuration, a larger three-axis acceleration sensor 40 can be mounted, and an impact (accelerations Ax, Ay, and Az) can be detected with higher accuracy.

Even in the second embodiment, the same effect as in the first embodiment described above can be obtained.

### THIRD EMBODIMENT

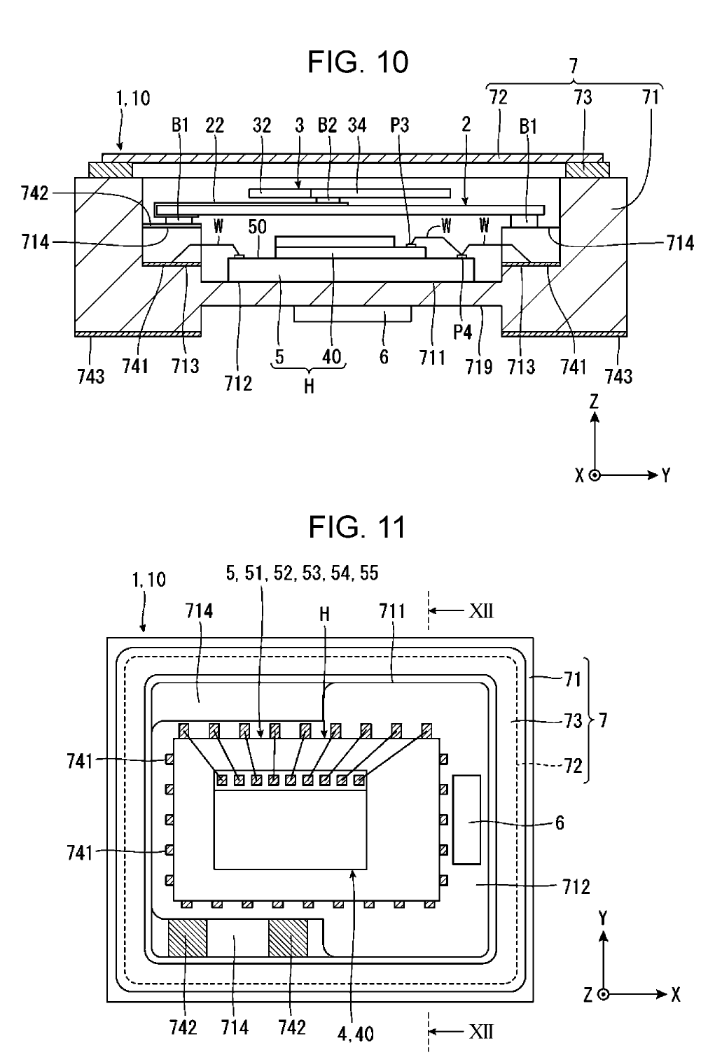

FIG. 10 is a cross-sectional view of a vibrator device according to a third embodiment.

A vibrator device 1 of the present embodiment is the same as the vibrator device 1 of the first embodiment described above, except that a configuration of a package 7 and a disposition of a battery 6 are different therefrom. In the following description, the present embodiment will be described with a focus on differences from the first embodiment described above, and the description of the same matters will not be repeated. In addition, in the drawing of the present embodiment, the same reference numerals are assigned to the same configurations as in the embodiment described above.

As illustrated in FIG. 10, the vibrator device 1 of the present embodiment has a recessed portion 719 that is open on a lower surface in addition to the recessed portion 711 of a base 71 of the package 7 which is open on an upper surface. Then, the battery 6 is accommodated in the recessed portion 719. The battery 6 is bonded to a bottom surface of the recessed portion 719 through a bonding member (not illustrated). In addition, the battery 6 overlaps a circuit element 5 in a plan view from the Z-axis direction. In this way, by disposing the battery 6 to overlap the circuit element 5, for example, a planar spread of the vibrator device 1 in the X-axis direction and the Y-axis direction can be further suppressed compared to the first embodiment described above, and the vibrator device 1 can be further reduced in size. In addition, with such a configuration, the battery 6 is exposed to the outside of the package 7, and thus, the battery 6 can be easily replaced. Therefore, the vibrator device 1 can be easily reused.

Even in the third embodiment described above, the same effect as in the first embodiment described above can be obtained.

### FOURTH EMBODIMENT

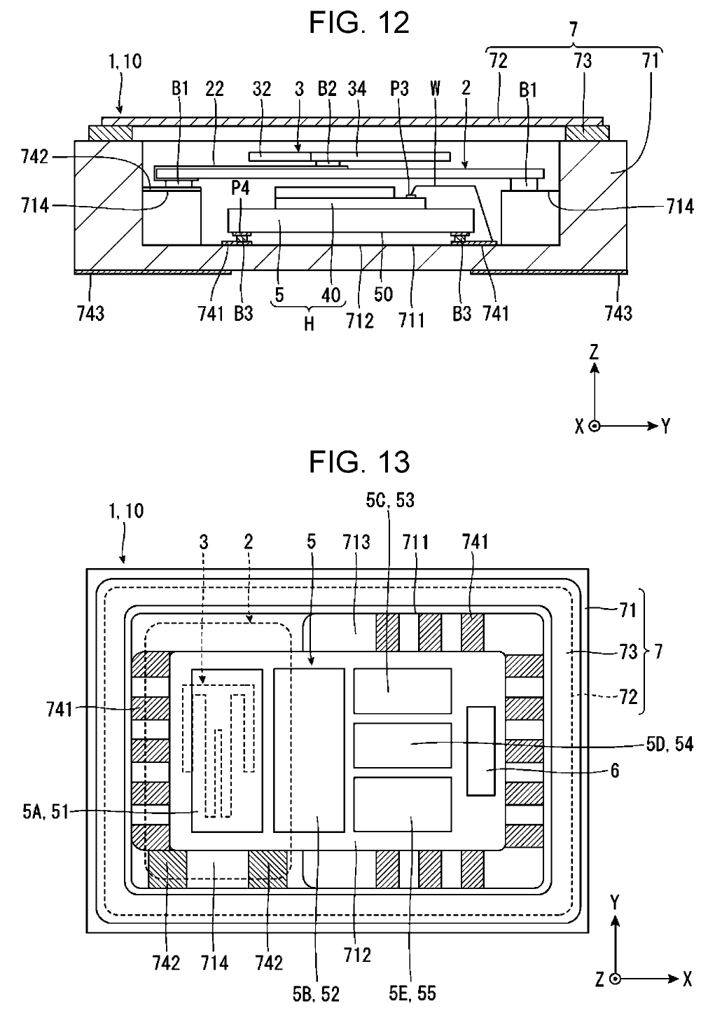

FIG. 11 is a top view of a vibrator device according to a fourth embodiment. FIG. 12 is a cross-sectional view taken along line XII-XII of FIG. 11. In FIG. 11, a support substrate 2 and a vibration element 3 are not illustrated for the sake of convenience of description.

A vibrator device 1 of the present embodiment is the same as the vibrator device 1 of the first embodiment described above, except that a method of mounting a circuit element 5 is different therefrom. In the following description, the present embodiment will be described with a focus on differences from the first embodiment described above, and the description of the same matters will not be repeated. In addition, in each drawing of the present embodiment, the same reference numerals are assigned to the same configurations as in the embodiment described above.

In the first embodiment described above, the circuit element 5 is bonded to the bottom surface 712 in a posture in which the active surface 50 faces an upper side, but in the present embodiment, as illustrated in FIGS. 11 and 12, the circuit element 5 is flip chip bonding (FCB) mounted on the bottom surface 712 in a posture in which an active surface 50 faces a lower side. A plurality of first internal terminals 741 are disposed on the bottom surface 712, and each coupling terminal P4 of the circuit element 5 is electrically coupled to a corresponding first internal terminal 741 through a conductive bonding member B3 such as a gold ball. With such a configuration, a first step difference surface 713 can be omitted, and thus, the vibrator device 1 can be reduced in size.

Even in the fourth embodiment, the same effect as in the first embodiment described above can be obtained.

### FIFTH EMBODIMENT

FIG. 13 is a top view of a vibrator device according to a fifth embodiment. In FIG. 13, for the sake of convenience of description, members unnecessary for description, such as a three-axis acceleration sensor 40, a coupling terminal P3, and a wire W, are not illustrated.

A vibrator device 1 of the present embodiment is the same as the vibrator device 1 of the first embodiment described above, except that a configuration of a circuit element 5 is different therefrom. In the following description, the present embodiment will be described with a focus on differences from the first embodiment described above, and the description of the same matters will not be repeated. In addition, in the drawing of the present embodiment, the same reference numerals are assigned to the same configurations as in the embodiment described above.

In the first embodiment described above, the circuit element 5 is configured with one element, but in the present embodiment, the circuit element 5 is configured with a plurality of elements. Specifically, as illustrated in FIG. 13, the circuit element 5 is configured by being divided into a first circuit element 5A in which an oscillation circuit 51 is formed, a second circuit element 5B in which a time measurement circuit 52 is formed, a third circuit element 5C in which a sensor circuit 53 is formed, a fourth circuit element 5D in which a memory circuit 54 is formed, and a fifth circuit element 5E in which an interface circuit 55 is formed. In this way, by configuring the circuit element 5 with a plurality of elements, the degree of freedom of a disposition of the circuit element 5 increases. In a case of the present embodiment, at least one of the first to fifth circuit elements 5A to 5E may overlap a support substrate 2 and a vibration element 3 in a plan view from the Z-axis direction, and in the illustrated example, the oscillation circuit 51 overlaps the support substrate 2 and the vibration element 3.

Even in the fifth embodiment, the same effect as in the first embodiment described above can be obtained. However, the configuration of the vibrator device 1 is not limited in particular, and for example, the circuit element 5 may be configured by being divided into two to four or six or more circuit elements. In addition, circuits included in each circuit element can also be combined with one or two or more circuits as appropriate.

### SIXTH EMBODIMENT

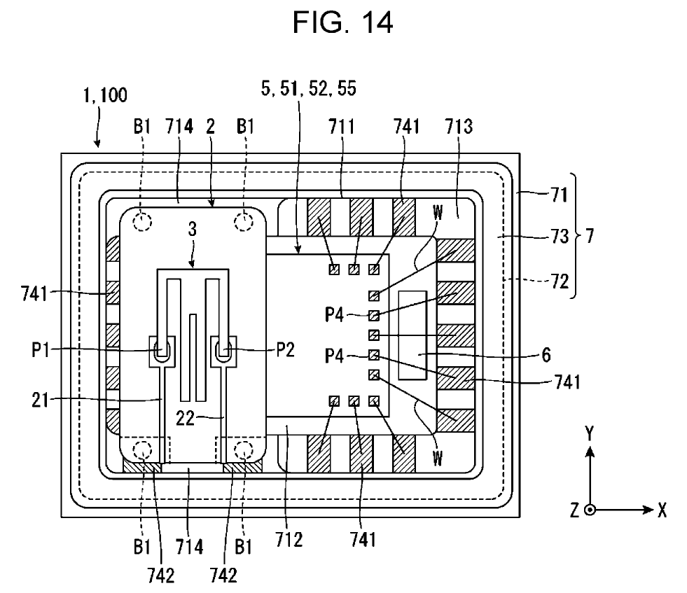

FIG. 14 is a top view of a vibrator device according to a sixth embodiment.

A vibrator device 1 of the present embodiment is the same as the vibrator device 1 of the first embodiment described above, except that the vibrator device 1 is used for a real-time clock 100. In the following description, the present embodiment will be described with a focus on differences from the first embodiment described above, and the description of the same matters will not be repeated. In addition, in the drawing of the present embodiment, the same reference numerals are assigned to the same configurations as in the embodiment described above.

As illustrated in FIG. 14, the vibrator device 1 of the present embodiment is the real-time clock 100 for generating time data Dt. The real-time clock 100 includes a support substrate 2, a vibration element 3, a circuit element 5, a battery 6, and a package 7 that accommodates the respective portions. In addition, the circuit element 5 includes a temperature compensated oscillation circuit 51 that causes the vibration element 3 to oscillate, a time measurement circuit 52 that generates the time data Dt, and an interface circuit 55 for performing communication with the outside. In the real-time clock 100, the oscillation circuit 51 causes the vibration element 3 to oscillate to generate a clock signal CLK, and the time measurement circuit 52 measures time based on the clock signal CLK to generate the time data Dt. Then, the generated time data Dt is output through the interface circuit 55.

Even in the sixth embodiment, the same effect as in the first embodiment described above can be obtained.

As described above, a vibrator device of the present disclosure is described based on the illustrated embodiments, but the present disclosure is not limited thereto. A configuration of each portion of the present disclosure can be replaced with any configuration having the same function. In addition, any other configuration may be added to the present disclosure. For example, when power can be supplied from the outside, the battery 6 may be omitted. In addition, in the embodiments described above, the physical quantity sensor 4 is the three-axis acceleration sensor 40, but the physical quantity sensor 4 is not limited in particular and may be, for example, a sensor that can detect a physical quantity other than acceleration, such as velocity, angular velocity, air pressure, pressure, temperature, and humidity.

What is claimed is:

1. A vibrator device comprising:
a support substrate;
a vibration element disposed on the support substrate;
a circuit element including an oscillation circuit that causes the vibration element to oscillate and a time measurement circuit that generates time data; and
a package that accommodates the support substrate, the vibration element, and the circuit element, wherein,
in a plan view of the support substrate, the circuit element overlaps the support substrate and the vibration element.

2. The vibrator device according to claim 1, wherein
a real-time clock is configured by generating a clock signal as the oscillation circuit causes the vibration element to oscillate and by generating time data as the time measurement circuit performs time measurement based on the clock signal.

3. The vibrator device according to claim 2, further comprising:
a physical quantity sensor that detects a physical quantity,
wherein the circuit element includes a sensor circuit that processes an output signal of the physical quantity sensor, and a memory circuit that stores processing data processed by the sensor circuit and the time data in association with each other.

4. The vibrator device according to claim 3, wherein
the physical quantity sensor is disposed in the package and overlaps the circuit element in a plan view of the support substrate.

5. The vibrator device according to claim 4, wherein
the package includes a base that has a recessed portion and a lid that closes an opening of the recessed portion and is coupled to the base,
a stacked body in which the circuit element and the physical quantity sensor are stacked is disposed on a bottom surface of the recessed portion,
the support substrate supported by the base is disposed on a lid side of the stacked body, and
the vibration element is disposed on a surface of the support substrate on the lid side.

6. The vibrator device according to claim 5, wherein
the circuit element is disposed on the bottom surface of the recessed portion, and
the physical quantity sensor is disposed on a surface of the circuit element on the lid side.

7. The vibrator device according to claim 5, wherein
the physical quantity sensor is disposed on the bottom surface of the recessed portion, and
the circuit element is disposed on a surface of the physical quantity sensor on the lid side.

8. The vibrator device according to claim 3, wherein
the circuit element includes a temperature sensor circuit that detects temperature, and
the memory circuit stores temperature data detected by the temperature sensor circuit, the processing data processed by the sensor circuit, and the time data in association with each other.
